(19) United States
(12) Patent Application Publication
(10) Pub. No.: US 2014/0115802 A1
(43) Pub. Date: May 1, 2014

(54) Motorized Drain Snake

(71) Applicant: Mu-Tsun Yu, Taichung City (TW)

(72) Inventor: Mu-Tsun Yu, Taichung City (TW)

(21) Appl. No.: 13/664,496

(22) Filed: Oct. 31, 2012

(51) Int. Cl. B08B 9/04

(52) U.S. Cl. 15/104.33

(57) ABSTRACT

A motorized drain snake includes a flexible member and a coupling. The flexible member has a first end provided with a hollow threaded portion and a second end provided with a tip portion. The coupling has a first end provided with a threaded connecting portion screwed into the threaded portion of the flexible member and a second end provided with a plurality of engaging slots for being connected with a powered tool. When in use, the powered tool is started to rotate the flexible member so that the tip portion of the flexible member is turned and extended deeply into a U-shaped channel of a toilet so as to pick and clear the clog, blockage or stoppage in the U-shaped channel.

### BACKGROUND OF THE INVENTION

1. Field of the Invention

The present invention relates to a drain snake and, more particularly, to a motorized drain snake for a toilet, sink, drain, waste pipe and the like.

2. Description of the Related Art

A conventional drain snake comprises a handle and a flexible member connected with the handle. When in use, the user can hold the handle to extend the flexible member into an object, such as a toilet, sink, drain, waste pipe and the like, so as to clear and remove a clog, blockage or stoppage (such as hairs, excrement and the like) in the object. However, the user has to operate and turn the drain snake manually, thereby causing inconvenience to the user, and thereby wasting the user's force and energy. In addition, the flexible member is connected with the handle by soldering so that the conventional drain snake is not assembled easily and quickly, thereby increasing the cost of assembly and fabrication. Further, the flexible member cannot be folded when not in use, thereby causing inconvenience in and increasing the costs of packaging, storage, carrying, display and exhibition of the conventional drain snake.

### BRIEF SUMMARY OF THE INVENTION

In accordance with the present invention, there is provided a drain snake, comprising a flexible member and a coupling connected with the flexible member. The flexible member is an elongate coiled spring made of a metallic wire. The flexible member has a first end provided with a hollow threaded portion and a second end provided with a tip portion. The coupling has a first end provided with a threaded connecting portion screwed into the threaded portion of the flexible member. The coupling has a second end provided with a plurality of engaging slots for being connected with a powered tool so as to transmit an electric power from the powered tool to the flexible member so that the flexible member is rotated in concert with the powered tool.

Preferably, the tip portion of the flexible member has a conical volute shape with different diameter and different distances according the practical requirement.

The coupling has a mediate portion provided with a through hole. The through hole of the coupling is extended in a radial direction of the coupling. The motorized drain snake further comprises a connecting member having a first end mounted in the through hole of the coupling, a snap ring connected with a second end of the connecting member, and a hanging hook connected with the snap ring. The tip portion of the flexible member is hooked onto the hanging hook so that the flexible member is bent and folded so as to reduce the whole volume of the motorized drain snake.

When in use, the powered tool is started to rotate the flexible member so that the tip portion of the flexible member is turned and extended deeply into a U-shaped channel of a toilet so as to pick and clear the clog, blockage or stoppage in the U-shaped channel of the toilet.

The primary objective of the present invention is to provide a motorized drain snake that is operated automatically without needing a manual work.

According to the primary advantage of the present invention, the flexible member is driven by the powered tool so that the motorized drain snake is operated automatically to clear and remove the clog, blockage or stoppage, thereby saving the user's energy, and thereby saving the working time.

According to another advantage of the present invention, the threaded connecting portion of the coupling is screwed into the threaded portion of the flexible member to connect the coupling with the flexible member integrally so that it is unnecessary to combine the coupling with the flexible member by soldering, thereby simplifying the working process, and thereby decreasing the cost of fabrication.

According to a further advantage of the present invention, the tip portion of the flexible member can be hooked onto the hanging hook so that the flexible member is bent and folded when not in use so as to reduce the whole volume of the motorized drain snake, thereby facilitating packaging, storage, carrying, display and exhibition of the motorized drain snake.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a motorized drain snake in accordance with the preferred embodiment of the present invention.

FIG. 2 is an exploded perspective view of the motorized drain snake as shown in FIG. 1.

FIG. 3 is a partially top cross-sectional view of the motorized drain snake as shown in FIG. 1.

FIG. 4 is a schematic operational view of the motorized drain snake as shown in FIG. 3 in assembly.

FIG. 5 is a perspective folded view of the motorized drain snake as shown in FIG. 1.

FIG. 6 is a schematic cross-sectional operational view of the motorized drain snake as shown in FIG. 1 in use.

FIG. 7 is a schematic operational view of the motorized drain snake as shown in FIG. 6.

### DETAILED DESCRIPTION OF THE INVENTION

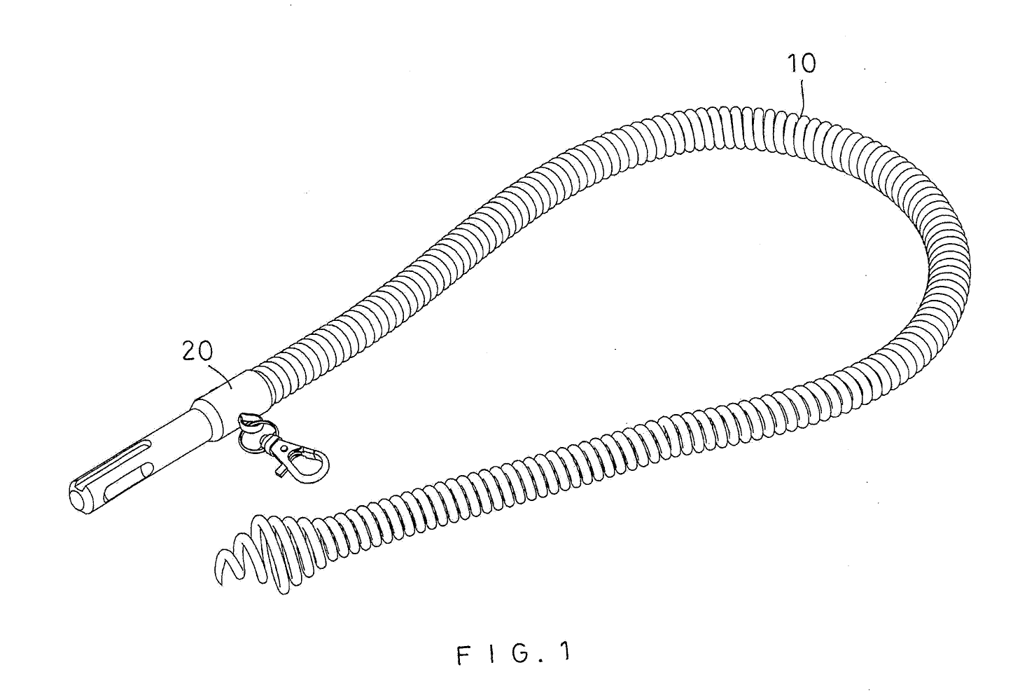

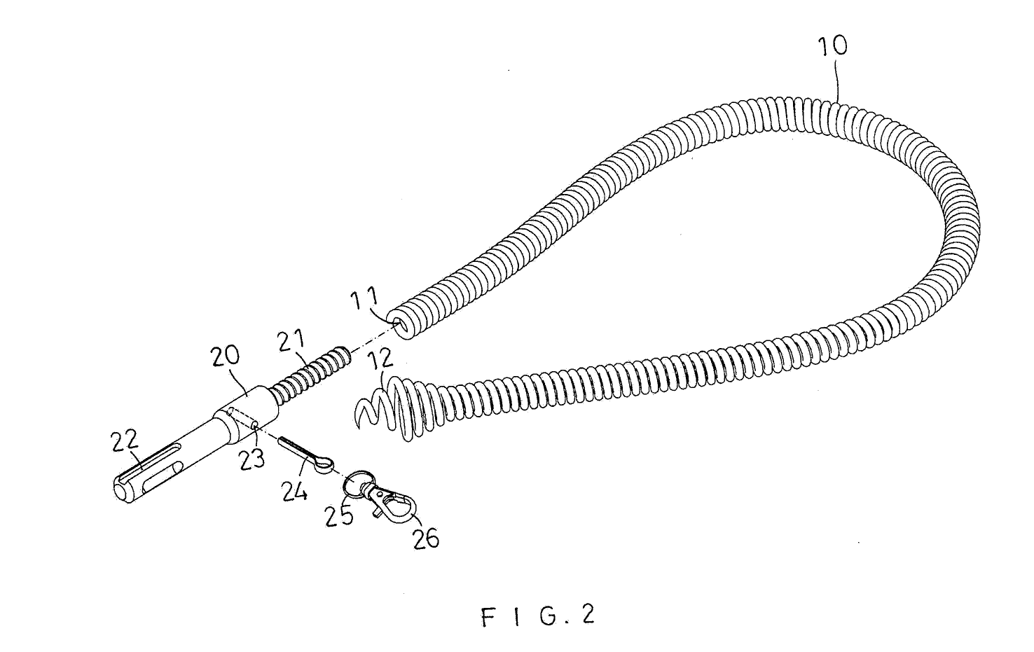

Referring to the drawings and initially to FIGS. 1-3, a motorized drain snake in accordance with the preferred embodiment of the present invention comprises a flexible member 10 and a coupling 20 connected with the flexible member 10.

The flexible member 10 is an elongate coiled spring made of a metallic wire. The flexible member 10 has a first end provided with a hollow threaded portion 11 and a second end provided with a tip portion 12 to dislodge a clog, blockage or stoppage (such as hairs, excrement and the like) in an object, such as a toilet, sink, drain, waste pipe and the like. The tip portion 12 of the flexible member 10 has a conical volute shape with different diameter and different distances according the practical requirement.

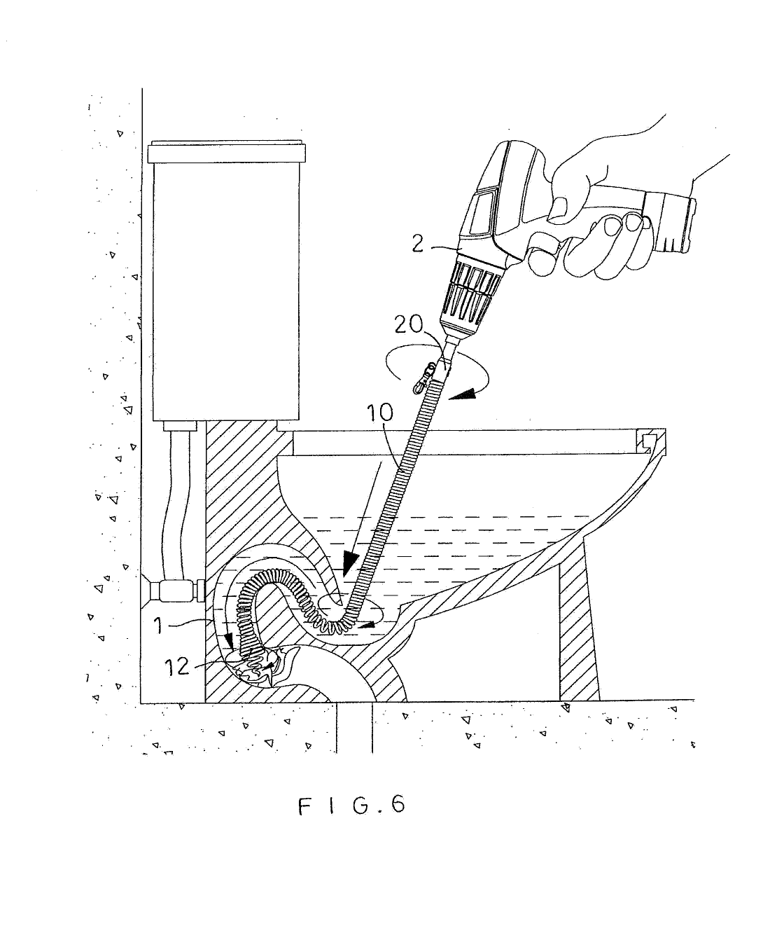

The coupling 20 has a first end provided with a threaded connecting portion 21 screwed into the threaded portion 11 of the flexible member 10. The coupling 20 has a second end provided with a plurality of engaging slots 22 for being connected with a powered tool 2 (such as an electric drill) as shown in FIG. 6, so as to transmit an electric power from the powered tool 2 to the flexible member 10 so that the flexible member 10 is rotated in concert with the powered tool 2. Each of the engaging slots 22 of the coupling 20 is extended in a longitudinal direction of the coupling 20. The engaging slots 22 of the coupling 20 are equally distant from each other. The coupling 20 has a mediate portion provided with a through hole 23. The through hole 23 of the coupling 20 is extended in a radial direction of the coupling 20.

The motorized drain snake further comprises a connecting member 24 having a first end mounted in the through hole 23 of the coupling 20, a snap ring 25 connected with a second end of the connecting member 24, and a hanging hook 26 connected with the snap ring 25.

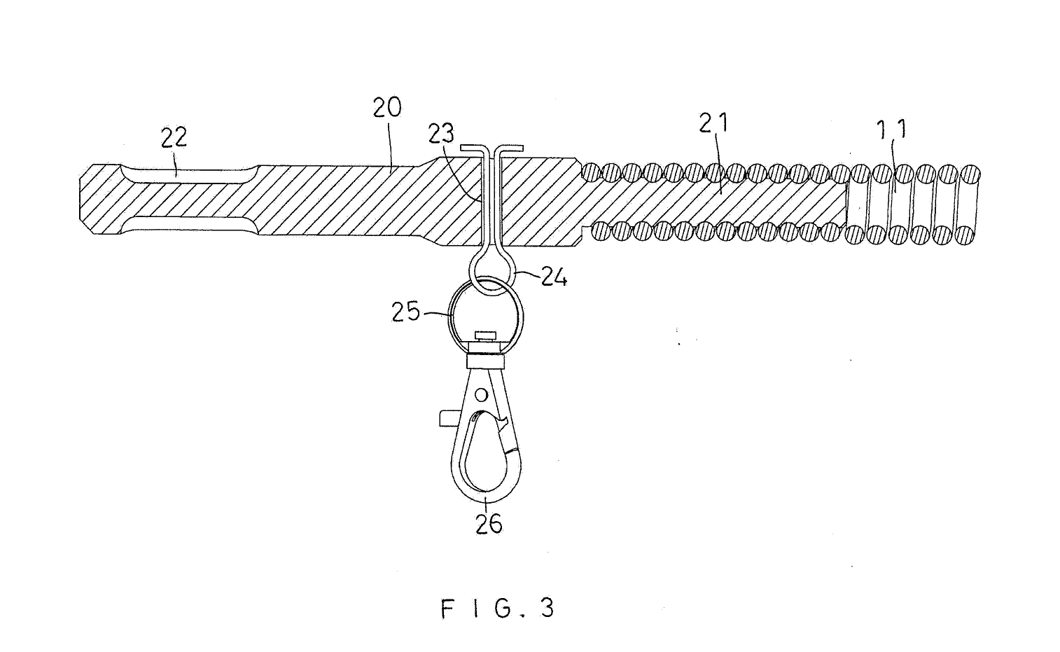

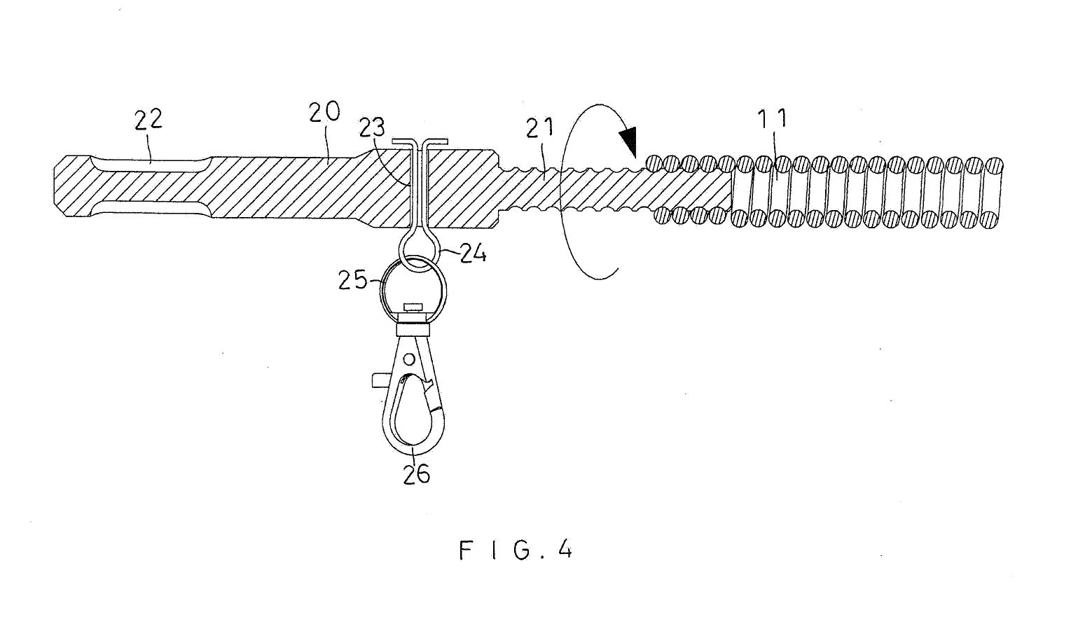

As shown in FIGS. 3 and 4, the threaded connecting portion 21 of the coupling 20 is screwed into the threaded portion 11 of the flexible member 10 to connect the coupling 20 with the flexible member 10 integrally.

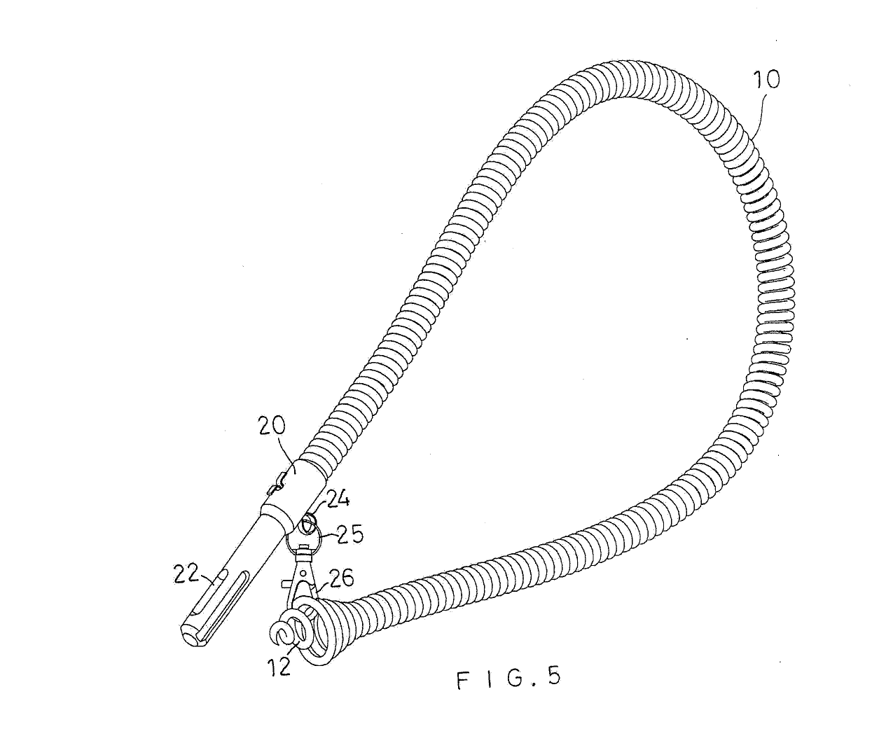

As shown in FIG. 5, the tip portion 12 of the flexible member 10 is hooked onto the hanging hook 26 so that the flexible member 10 is bent and folded when not in use so as to reduce the whole volume of the motorized drain snake, thereby facilitating packaging, storage, carrying, display and exhibition of the motorized drain snake.

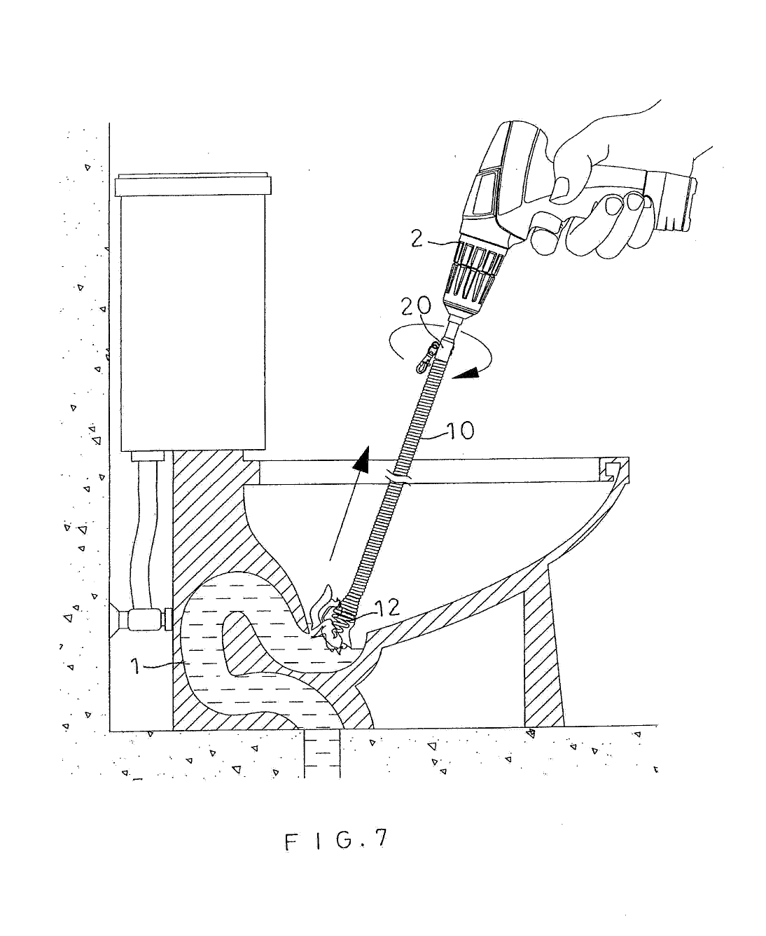

In operation, referring to FIGS. 6 and 7 with reference to FIGS. 1-3, the engaging slots 22 of the coupling 20 engage the powered tool 2 to connect the coupling 20 with the powered tool 2. Then, the tip portion 12 of the flexible member 10 is inserted into a substantially U-shaped channel 1 of a toilet. Then, the powered tool 2 is started to rotate the flexible member 10 so that the tip portion 12 of the flexible member 10 is turned and extended deeply into the U-shaped channel 1 of the toilet so as to pick and clear the clog, blockage or stoppage in the U-shaped channel 1 of the toilet as shown in FIG. 6. Then, the flexible member 10 is pulled outward to detach the tip portion 12 of the flexible member 10 from the U-shaped channel 1 of the toilet so as to dislodge and remove the clog, blockage or stoppage from the U-shaped channel 1 of the toilet as shown in FIG. 7.

Accordingly, the flexible member 10 is driven by the powered tool 2 so that the motorized drain snake is operated automatically to clear and remove the clog, blockage or stoppage, thereby saving the user's energy, and thereby saving the working time. In addition, the threaded connecting portion 21 of the coupling 20 is screwed into the threaded portion 11 of the flexible member 10 to connect the coupling 20 with the flexible member 10 integrally so that it is unnecessary to combine the coupling 20 with the flexible member 10 by soldering, thereby simplifying the working process, and thereby decreasing the cost of fabrication. Further, the tip portion 12 of the flexible member 10 can be hooked onto the hanging hook 26 so that the flexible member 10 is bent and folded when not in use so as to reduce the whole volume of the motorized drain snake, thereby facilitating packaging, storage, carrying, display and exhibition of the motorized drain snake.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A drain snake, comprising:
a flexible member; and
a coupling connected with the flexible member; wherein:
the flexible member is an elongate coiled spring made of a metallic wire;
the flexible member has a first end provided with a hollow threaded portion and a second end provided with a tip portion;
the coupling has a first end provided with a threaded connecting portion screwed into the threaded portion of the flexible member; and
the coupling has a second end provided with a plurality of engaging slots for being connected with a powered tool so as to transmit an electric power from the powered tool to the flexible member so that the flexible member is rotated in concert with the powered tool.

2. The drain snake of claim 1, wherein the tip portion of the flexible member has a conical volute shape with different diameter and different distances according the practical requirement.

3. The drain snake of claim 1, wherein:
the coupling has a mediate portion provided with a through hole;
the through hole of the coupling is extended in a radial direction of the coupling;
the motorized drain snake further comprises:
a connecting member having a first end mounted in the through hole of the coupling;
a snap ring connected with a second end of the connecting member; and
a hanging hook connected with the snap ring; wherein:
the tip portion of the flexible member is hooked onto the hanging hook so that the flexible member is bent and folded so as to reduce the whole volume of the motorized drain snake.
